(19) United States
(12) Patent Application Publication
(10) Pub. No.: US 2021/0383547 A1
(43) Pub. Date: Dec. 9, 2021

(54) MEDICAL IMAGE PROCESSING

(71) Applicant: UNIVERSITY OF SHEFFIELD, Sheffield (GB)

(72) Inventors: Haiping Lu, Sheffield (GB); Andrew Swift, Sheffield (GB)

(21) Appl. No.: 17/287,211

(22) PCT Filed: Oct. 23, 2019
(86) PCT No.: PCT/GB2019/053014

§ 371 Date: Apr. 21, 2021

(30) Foreign Application Priority Data
Oct. 23, 2018 (GB) 1817238.7

(51) Int. Cl. G06T 7/11; G06T 7/33; G06T 3/40

(52) U.S. Cl. CPC G06T 7/11; G06T 7/33; G06T 3/4084; G06T 2207/20101; G06T 2207/10088; G06T 2207/10132; G06T 2207/20084; G06T 2207/10081

(57) ABSTRACT

There is described a method of generating data indicative of a condition of an internal organ, the method comprising: receiving a plurality of images representing the internal organ; receiving landmark data associated with a selected image of the plurality of images; processing the landmark data and the selected image to extract a region of interest in the plurality of images; and processing the region of interest in the plurality of images to generate data indicative of a condition of the internal organ.

### TECHNICAL FIELD

This specification relates to methods and systems for generating data indicative of a condition of an internal organ, in particular internal organs having an associated physiological cycle.

### BACKGROUND

Machine learning methods are increasingly being used to aid in medical diagnosis. In particular, machine learning methods have been applied to process medical images such as those obtained from magnetic resonance imaging (MRI) or computed tomography (CT) scans. However, the effectiveness of machine learning methods when applied to medical imaging is limited by the high dimensional nature of medical images and the small datasets available. Therefore, there is a need for improved methods to facilitate processing of medical images using machine learning methods.

### SUMMARY

According to a first aspect, there is provided a method of generating data indicative of a condition of an internal organ, the method comprising: receiving a plurality of images representing the internal organ; receiving landmark data associated with a selected image of the plurality of images; processing the landmark data and the selected image to extract a region of interest in the plurality of images; and processing the region of interest in the plurality of images to generate data indicative of a condition of the internal organ.

In prior art methods, data indicative of a condition of the internal organ may be derived based upon manual segmentation of one or more images representing the organ. Such manual segmentation is highly time consuming and difficult to perform accurately. Automatic segmentation methods also exist, however, these are only as accurate as the manual segmentations used to train such systems and typically have difficulty where organs change shape over time during their normal function.

The inventors have realised that data indicative of a condition of the internal organ can be generated by processing a region of interest in a plurality of images, the region of interest extracted by processing landmark data associated with a selected image of the plurality of images. Given that identification of landmarks can be performed faster and more accurately than full segmentation, the methods described herein provide a more efficient method for generating data indicative of a condition of an internal organ.

Where the data indicative of a condition is generated through machine learning techniques, the inventors have realised that it is not necessary to perform a full segmentation of the image and that an approximate region of interest focused on the internal organ is sufficient to generate accurate data indicative of a condition of the internal organ. As such, the use of landmark data to extract a region of interest provides a simple yet effective and efficient means of pre-processing image data for use in machine learning techniques for generating data indicative of a condition of an internal organ, where without such pre-processing, the generated data may lack accuracy given the inherent difficulty of processing medical image data.

The plurality of images may comprise a first image associated with a first time point and a second image associated with a second time point. For example, the first image may be obtained prior to an application of a contrasting agent and a second image may be obtained after the application of the contrasting agent. It will be appreciated that there may be a first subset of images of the plurality of images associated with the first time point and a second subset of images of the plurality of images associated with the second time point.

The internal organ may be associated with a physiological cycle and the plurality of images may represent the physiological cycle. The physiological cycle may be a cardiac cycle or a respiratory cycle. The plurality of images may therefore be a series of images obtained over a period of time, such as over one cardiac cycle or one respiratory cycle. In this way, the plurality of images may together represent the functioning of the internal organ over time. It will be appreciated that the plurality of images may comprise a series of sets of images obtained over the physiological cycle, with each set of images associated with a particular point in time over the duration of the physiological cycle. For example, each set of images may comprise a plurality of cross-sectional image slices of the internal organ.

The plurality of images may be obtained using an MRI scan, CT scan or ultrasound scan.

The landmark data associated with the selected image may comprise one or more landmarks. Processing the landmark data and the selected image to extract a region of interest in the plurality of images may comprise: receiving reference landmark data comprising one or more reference landmarks corresponding to the one or more landmarks associated with the selected image; determining a transformation to align the one or more landmarks associated with the selected image to the one or more reference landmarks; applying the transformation to each of the plurality of images; and extracting the region of interest based upon the transformed plurality of images. The transformation may include any combination of an image rotation, translation, scaling, flipping and any other suitable transformations in order to transform the selected image into the frame of reference defined by the one or more reference landmarks. That is, the transformation may warp the selected image such that the size, position and orientation of the internal organ depicted in the selected image are consistent across all patients.

The method may further comprise receiving data indicating a location of a bounding shape defined relative to the one or more reference landmarks; and extracting a region of interest in each image of the transformed plurality images based upon a location in each image of the transformed plurality images corresponding to the location of the bounding shape. In this way, the bounding shape and its location need only be determined once based upon the one or more reference landmarks and may then be applied to any transformed image from any patient to extract the region of interest.

The method may further comprise determining the bounding shape. The bounding shape may enclose the one or more reference landmarks. Determining the bounding shape may comprise determining a minimum bounding shape that encloses the one or more reference landmarks. Alternatively, one or more of the one or more reference landmarks may be located outside of the bounding shape.

The bounding shape may be a circle or ellipse or an equivalent three dimensional shape. Extracting a region of interest in each image of the plurality of images may comprise masking each image of the plurality of images outside of the bounding shape. For example, the parts of each image outside of the bounding shape may be blacked out whilst the parts of each image inside the bounding shape remain unaltered. In this way, less relevant parts of each image for determining a condition of the internal organ may be removed such that processing of the plurality of images is based only on the most relevant parts of each image.

The method may further comprise downscaling a resolution of the plurality of images. In this way, processing may be improved efficiency without adversely affecting the accuracy of the generated data.

Processing the region of interest in the plurality of images to generate data indicative of a condition of the internal organ may be based upon a machine learning technique. Processing the region of interest may further comprise applying a classifier to generate data indicative of a condition of the internal organ.

Processing the region of interest may further comprise generating image features based upon a tensor-based machine learning technique applied to the region of interest in the plurality of images; and applying a classifier to the image features to generate data indicative of a condition of the internal organ. For example, the tensor-based machine learning technique may be Multilinear Principal Component Analysis (MPCA). The feature extraction process may also serve the purpose of dimensionality reduction which can improve the efficiency of both training of the machine learning model and processing using the model.

The method may further comprise applying a feature selection technique to select image features; and applying the classifier to the selected image features to generate data indicative of a condition of the internal organ. The feature selection technique may be based upon a Fisher discriminant ratio. In this way, the most relevant features for generating data indicating a condition of the internal organ may be selected, thus providing an efficient yet effective means of dimensionality reduction.

The classifier may be a linear classifier. For example, the linear classifier may be Support Vector Machine (SVM) with a linear kernel or logistic regression based. By using a linear classifier, the generated data can be more easily interpreted compared to a non-linear classifier such as a neural network.

The method may further comprise monitoring the condition of the internal organ by comparing the data indicative of a condition of the internal organ to previously generated data indicative of a condition of the internal organ.

According to another aspect, there is provided a computer apparatus for generating data indicative of a condition of an internal organ comprising: a memory storing processor readable instructions; a processor arranged to read and execute instructions in said memory; wherein said processor readable instructions comprise instructions arranged to control the computer to carry out a method according to the first aspect.

According to a further aspect, there is provided a non-transitory computer readable medium carrying computer readable instructions configured to cause a computer to carry out a method according to the first aspect.

Aspects can be combined and it will be readily appreciated that features described in the context of one aspect can be combined with other aspects.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs.

### BRIEF DESCRIPTION OF THE FIGURES

Embodiments will now be described, by way of example, with reference to the accompanying drawings, in which:

FIG. 1 is a schematic illustration of a system according to an embodiment.

FIG. 1A is a schematic illustration of a computer of the system of FIG. 1 in more detail.

FIGS. 2A and 2B are exemplary images of the heart from two different patients, each image having corresponding landmarks identified. FIG. 3A shows the result of a transformation applied to the image of FIG. 2B.

FIG. 3B shows a region of interest extracted from the image of FIG. 3A.

FIG. 3C shows the (enlarged) result of a downscaling of the image of FIG. 3B.

FIG. 4 is a flowchart showing processing carried out for generating data indicative of a condition of an internal organ.

FIG. 5 is a flowchart showing more detailed processing.

FIG. 6 is a flowchart showing exemplary processing for generating data indicative of a condition of an internal organ in more detail.

### DETAILED DESCRIPTION

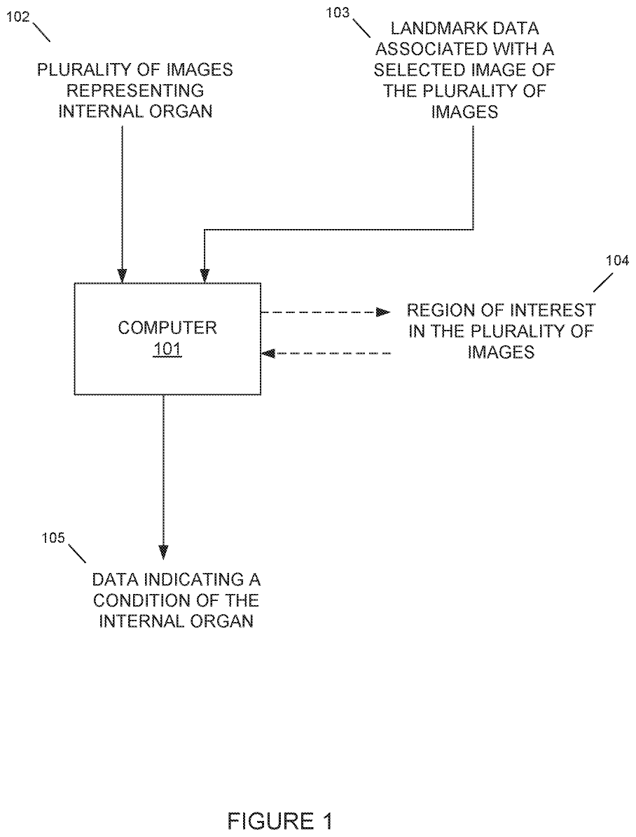

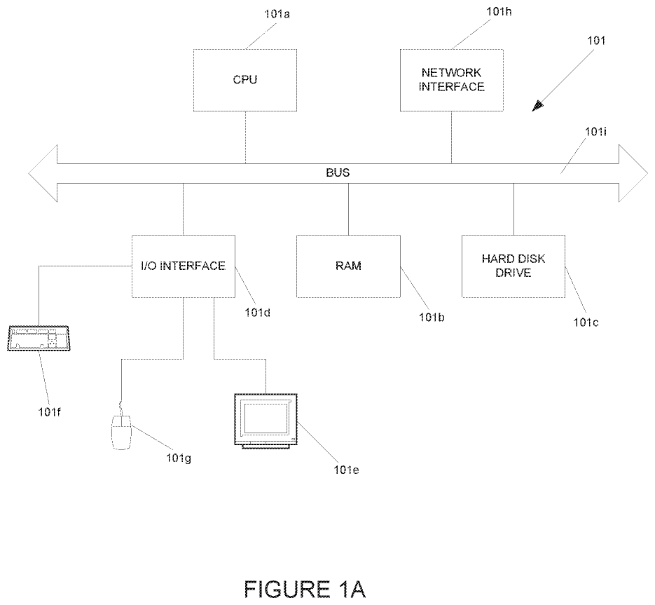

Referring now to FIG. 1, a computer 101 is arranged to receive a plurality of images 102 representing an internal organ. For example, the internal organ may be the heart, the lungs, the brain or the like. The plurality of images 102 may be obtained from a medical imaging process such as an MRI scan, CT scan, ultrasound scan or any other suitable imaging method that allows inspection of an internal organ.

The plurality of images 102 may comprise a “stack” of images associated with a single point in time. For example, the plurality of images may comprise a plurality of cross-sectional image slices through the internal organ. Alternatively, or in addition, the plurality of images 102 may comprise a series of images associated with a plurality of times. For example, a first subset of the plurality of images 102 may be obtained prior to an application of a contrasting agent and a second subset of the plurality of images 102 may be obtained after the application of the contrasting agent. In another example, the internal organ may be associated with a physiological cycle and the plurality of images may be representative of the physiological cycle. For example, the plurality of images 102 may be a series of images of the heart obtained over one cardiac cycle. Typically, 20 to 40 images may be obtained over one cardiac cycle. The plurality of images 102 may therefore together represent the functioning of the heart over time. In another example, the plurality of images 102 may be a series of images of the lungs obtained over a respiratory cycle. It is also possible for the plurality of images 102 to comprise a plurality of “stacks” of images, with each “stack” being associated with a particular point in time. For example, a plurality of cross-sectional images may be repeatedly obtained over a period of time, thereby providing a 4-dimensional series of images comprising a time series of 3D images.

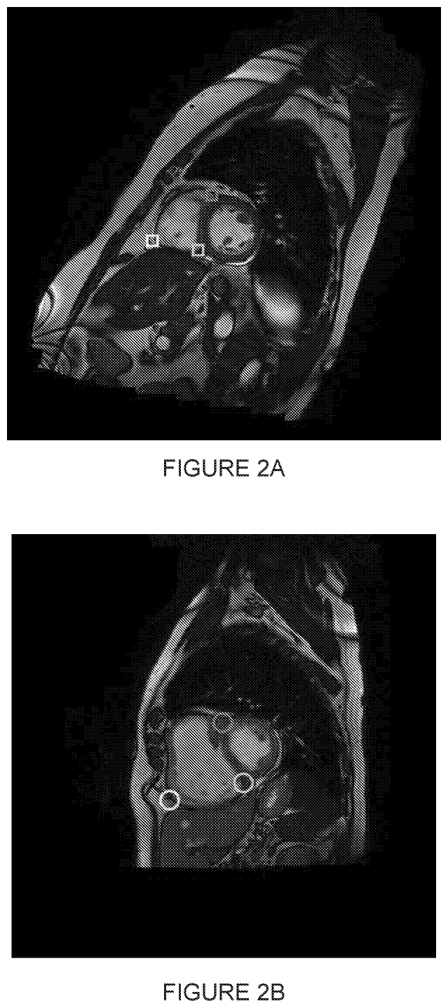

The computer 101 is further arranged to receive landmark data 103 associated with a selected image of the plurality of images 102. In general, the landmark data 103 may identify the location of known parts of the internal organ depicted in the selected image, thus the landmark data 103 aids in locating a region of interest in the plurality of images 104. For example, in short-axis CINE cardiac MRI images, the landmarks may correspond to inferior and superior hinge points and the inferolateral inflection point of the RV free wall as shown in FIGS. 2A and 2B. In 4-chamber CINE cardiac MRI images, the landmarks may correspond to LV apex, mitral and tricuspid annuli.

The landmark data may be obtained by manually marking the location of landmarks in the selected image. Alternatively, such landmarks may be automatically identified. The selected image may be the first image of the plurality of images 102. Alternatively, the selected image may be selected from the plurality of images 102 according to a criteria deemed suitable by a person skilled in the art.

The computer 101 is arranged to process the landmark data 103 and the selected image to extract a region of interest 104 in the plurality of images 102. For example, one or more landmarks may be marked on the selected image. A bounding shape such as a circle, ellipse, box or other shape defined relative to the one or more landmarks may be determined. For example, the bounding shape may enclose the one or more landmarks. Where there is a plurality of landmarks located on or close to the boundary of the internal organ depicted in the selected image, the bounding shape may be the minimal size required to enclose the plurality of landmarks for the given geometric bounding shape. If the location of the plurality of landmarks are not sufficiently close to the boundary of the internal organ or if there is only one landmark, then the size of the bounding shape may be determined such that the bounding shape encloses the one or the more landmarks and is suitably sized to enclose a region of interest focused on the internal organ as considered appropriate by a person skilled in the art. Alternatively, one or more of the one or more landmarks may be located outside of the bounding shape. For example, one landmark may be located at a bone structure near to the internal organ. As such a landmark is external to the internal organ, the bounding shape may be defined relative to such an external landmark to identify a region of interest around the internal organ. It will be appreciated that how to determine a bounding shape relative to or to enclose one or more points would be known to a person skilled in the art.

In the case of a series of 3D images, it will be appreciated that the bounding shape may be a three dimensional shape such as a sphere, ellipsoid, cuboid or other appropriate shape. Alternatively, a 2D bounding shape may be determined for each cross-sectional slice in the series of 3D images. The landmark data 103 may be associated with a single selected image of the series of 3D images, that is, one cross-sectional slice. Alternatively, the landmark data 103 may be associated with a plurality of selected images of the series of 3D images, that is, a plurality of cross-sectional slices from one particular set of cross-sectional slices that make up one 3D image. It will be appreciated that landmark data need not be required for every cross-sectional slice of a 3D image.

A region of interest may be extracted from each image of the plurality of images based upon the bounding shape at a corresponding location in each image. In this way, a region of interest may be extracted for each image of the plurality of images 102 using only data associated with one of the images of the plurality of images 102.

It will be appreciated that extracting a region of interest in this way requires the presence of a relatively small number of landmarks in the selected image. The inventors have found that reliable results may be achieved with as few as three landmarks. However, it may also be possible to use a single landmark, for example, by determining a bounding shape based upon the single landmark as a centre point or it may be possible to determine a bounding shape based upon a relationship between positions of two landmarks. Given that relatively few landmarks required, where a manual landmarking process is used, a medical professional, such as a radiologist, can perform such landmarking in a matter of seconds without difficulty as compared to full manual segmentation of the image. The landmarks may also be chosen to be easily identifiable parts of the internal organ, thus further improving efficiency.

Alternatively, instead of determining a bounding shape based upon the selected image, it is possible to determine a bounding shape based upon a reference image separate to the plurality of images 102. In more detail, the computer 101 may be configured to receive reference landmark data comprising one or more reference landmarks corresponding to the one or more landmarks associated with the selected image. The one or more reference landmarks may be obtained based upon a reference image in a similar manner described above with respect to obtaining landmark data associated with the selected image. The reference image may be a representative example obtained prior to processing. For example, the reference image may depict the internal organ at its peak size during a captured physiological cycle. The reference image may be obtained from any data set, for example, a training data set.

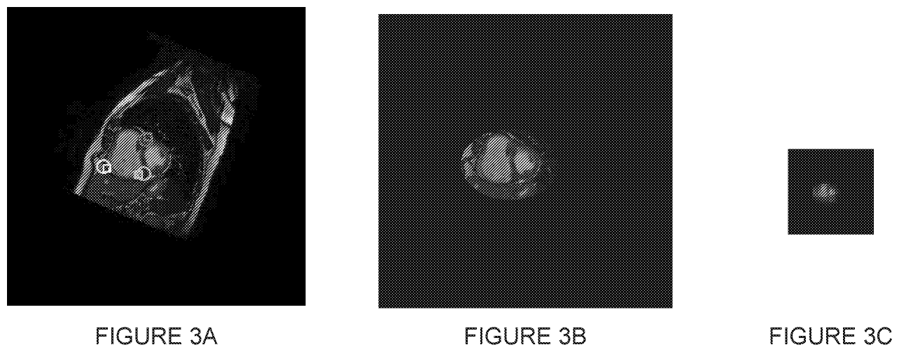

The computer 101 may be further configured to determine a transformation to align the one or more landmarks associated with the selected image to the one or more reference landmarks. The transformation may include any combination of an image rotation, translation, scaling, flipping and any other suitable transformations in order to transform the selected image into the frame of reference defined by the one or more reference landmarks. That is, the transformation may warp the selected image such that the size, position and orientation of the internal organ depicted in the selected image are consistent across all patients. For example, as shown in FIGS. 2A and 2B, images obtained from different patients may not be well aligned. As such, this may cause difficulty in accurately generating data indicative of a condition of the internal organ across patients. FIG. 3A shows a result of a transformation applied to the image of FIG. 2B based upon aligning the landmark data with that of the image of FIG. 2A as reference. The determined transformation may then be applied to the plurality of images 102 and the region of interest extracted based upon the transformed plurality of images.

The computed transformation may be verified by computing a distance between the location of the transformed landmarks of the selected image and the corresponding reference landmarks. If the computed distance exceeds a threshold, this may be indicative of a poor quality alignment and a visual inspection may be required. The transformation may be re-computed to obtain an acceptable alignment or a manual alignment may be carried out instead.

In extracting the region of interest in the transformed plurality of images, the computer 101 may be configured to receive data indicating a location of a bounding shape defined relative to the one or more reference landmarks. Alternatively, the computer 101 may be configured to receive the reference image upon which the reference landmarks are based and to determine the bounding shape relative to the one or more reference landmarks in a similar manner described above for determining a bounding shape for landmarks associated with the selected image.

The region of interest may be extracted in each image of the transformed plurality of images based upon a location in each image corresponding to the location of the bounding shape. In this way, the bounding shape and its location need only be determined once based upon the one or more reference landmarks and may then be applied to any transformed image from any patient to extract the region of interest.

In any case, the region of interest may be extracted by masking the parts of each image that are outside of the bounding shape. For example, the parts of each image outside of the bounding shape may be blacked out whilst the parts of each image inside the bounding shape remain unaltered. In this way, less relevant parts of each image for determining a condition of the internal organ may be removed such that processing of the plurality of images is based only on the most relevant parts of each image. An example masked image is shown in FIG. 3B.

The computer 101 is further arranged to process the region of interest 104 in the plurality of images 102 to generate data 105 indicative of a condition of the internal organ. For example, the processing may be used to determine a condition of the heart, in particular, whether a patient may be suffering from a disease such as pulmonary arterial hypertension. In another example, the processing may be used to determine a condition of the lungs, such as whether a patient may be suffering from a respiratory disease.

Processing to generate data 105 indicative of a condition of the internal organ may be based upon a machine learning process. For example, the data 105 may be generated using a linear classifier such as a Support Vector Machine (SVM) with a linear kernel or logistic regression. By using a linear classifier, the generated data 105 can be more easily interpreted compared to a non-linear classifier such as a neural network.

The plurality of images 102 may also be downscaled in resolution prior to processing to generate data 105 indicative of the internal organ. Where the plurality of images 102 is representative of a physiological cycle and the function of the organ over time is of interest rather than a detailed inspection of the structural features of the organ, it has been found that downscaling images provides processing efficiency without adversely affecting the accuracy of the generated data. This includes improved efficiencies in the process for training a machine learning model which may be used in the processing to generate the data 105 indicative of the internal organ. Downscaling can improve the efficiency of the training process whilst also maintaining the accuracy of the model and in some cases improving the accuracy of the model. Downscaling is particularly effective where the size of the training dataset is much smaller than the dimensionality of the plurality of images 102. FIG. 3C shows the result of a downscaling operation applied to the image of FIG. 3B (which has been enlarged for clarity).

The region of interest in the plurality of images 102 may be further processed prior to generating the data 105 indicative of the condition of the internal organ. For example, the region of interest 104 may be processed to generate image features which may be used as input to the classifier. The image features may be generated based upon a tensor-based machine learning technique such as Multilinear Principal Component Analysis (MPCA). In general, MPCA is a tensor-based extension of Principal Component Analysis (PCA) and is capable of modelling multidimensional structures efficiently compared to the vector-based modelling of conventional PCA which ignores such structures and leads to very high dimensional vectors. As such, MPCA is particularly suitable for modelling three dimensional structures of the organ or where there is a time-varying element, for example, where the plurality of images represents a physiological cycle. Further details of the MPCA procedure may be found in Lu, Haiping, Konstantinos N. Plataniotis, and Anastasios N. Venetsanopoulos. “MPCA: Multilinear principal component analysis of tensor objects.” IEEE transactions on Neural Networks, volume 19, no. 1 (2008): pp 18-39, which is hereby incorporated in its entirety by reference.

The feature extraction process may also serve the purpose of dimensionality reduction which can improve the efficiency of both training of the machine learning model and processing using the model. For example, a set of K images of size I×J, has dimensionality I×J×K, and may be reduced to a smaller dimensionality P×Q×R. The MPCA algorithm is capable of performing dimensionality reduction and feature extraction.

A feature selection technique may be used to select the most relevant features for generating data indicating a condition of the internal organ. For example, the feature selection technique may be based upon a Fisher discriminant ratio to select the most discriminative features for differentiating between two classes such as internal organs having a particular condition indicative of disease and internal organs that appear to be healthy. The subset of features that are to be selected may be pre-determined based upon applying a feature selection method on a training dataset. Each feature, for example those obtained using MPCA as described above, may be ranked according to a computed Fisher discriminant ratio and the highest ranking features may be selected. Cross validation may be used to determine how many of the top ranking features are to be selected. The selected features may be used as input to the classifier. Such a method for performing feature selection provides an efficient yet effective means of dimensionality reduction. Alternatively, other feature selection techniques may be used such as methods based upon mutual information.

FIG. 1A shows the computer 101 of FIG. 1 in further detail. It can be seen that the computer 101 comprises a CPU 101a which is configured to read and execute instructions stored in a volatile memory 101b which takes the form of a random access memory. The volatile memory 101b stores instructions for execution by the CPU 101a and data used by those instructions. For example, in use, the received plurality of images 102 representing the internal organ and the received landmark data 103 may be stored in volatile memory 101b.

The computer 101 further comprises non-volatile storage in the form of a hard disc drive 101c. The computer 101 further comprises an I/O interface 101d to which are connected peripheral devices used in connection with the computer 101. More particularly, a display 104e is configured so as to display output from the computer 101. The display 104e may, for example, display the output of the numerical simulation at a particular display resolution. Input devices are also connected to the I/O interface 101d. Such input devices include a keyboard 101f and a mouse 101g which allow interaction with the computer 101. Other input devices may also include gesture-based input devices. A network interface 101h allows the computer 101 to be connected to an appropriate computer network so as to receive and transmit data from and to other computing devices. The CPU 101a, volatile memory 101b, hard disc drive 101c, I/O interface 101d, and network interface 101h, are connected together by a bus 101i.

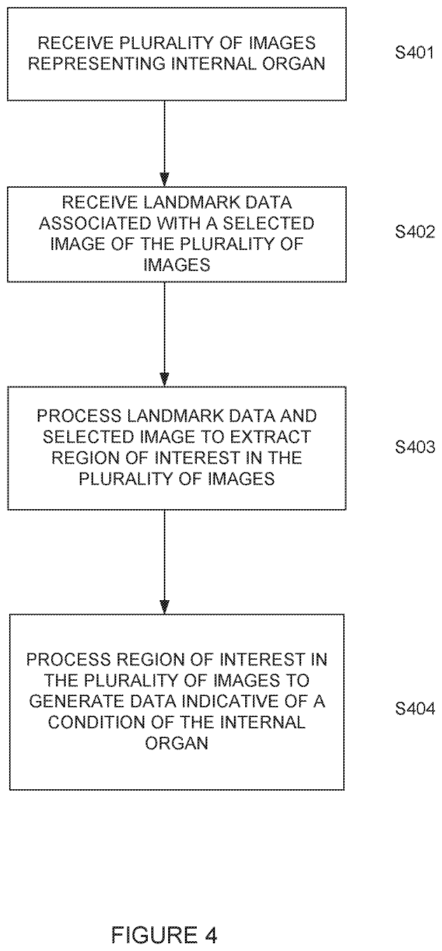

Referring now to FIG. 4, a process for generating data indicative of a condition of an internal organ is shown. As will be appreciated, the process may be implemented by the system of FIG. 1.

At step S401, a plurality of images 102 representing the internal organ is received. As discussed above, the plurality of images may be obtained from a medical imaging process such as an MRI or CT scan or any other suitable imaging method that allows inspection of an internal organ. The plurality of images 102 may comprise a “stack” of images associated with a single point in time, alternatively or in addition, the plurality of images 102 may be associated with a plurality of time points. For example, the plurality of images 102 may be representative of a physiological cycle of the internal organ such as a cardiac cycle or respiratory cycle. In another example, the plurality of images 102 may be a plurality of “stacks” of images, with each stack of images associated with a point in time.

At step S402, landmark data 103 associated with a selected image of the plurality of images 102 is received. As discussed above, the landmark data 103 may identify the location of known parts of the internal organ depicted in the selected image. The landmark data may be obtained by manually marking the location of landmarks in the selected image. Alternatively, such landmarks may be automatically identified. The selected image may be the first image of the plurality of images 102. Exemplary images with corresponding landmarks identified are shown in FIGS. 2A and 2B.

At step S403, the landmark data 103 and the selected image are processed to extract a region of interest 104 in the plurality of images 102. As discussed above, one or more landmarks may be marked on the selected image. A bounding shape such as a circle, ellipse, box or other shape, or a three-dimensional equivalent as appropriate, defined relative to the one or more landmarks may be determined. The bounding shape may enclose the one or more landmarks. The bounding shape may be the minimal size required to enclose the one or more landmarks for the given geometric bounding shape where the one or more landmarks are located close to the boundary of the internal organ depicted in the selected image. Otherwise, the size of the bounding shape may be determined such that bounding shape encloses a region of interest focused on the internal organ as considered appropriate by a person skilled in the art. Alternatively, one or more of the one or more landmarks may be located external to the internal organ and therefore would not be enclosed by the bounding shape. The bounding shape may be determined relative to such external landmarks.

A region of interest may be extracted from each image of the plurality of images based upon the bounding shape at a corresponding location in each image. The region of interest may be extracted by masking the parts of the image outside of the bounding shape. That is, the parts of the image outside of the bounding shape may be blacked out whilst the parts of image inside the bounding shape remain unaltered as shown in the example of FIG. 3B.

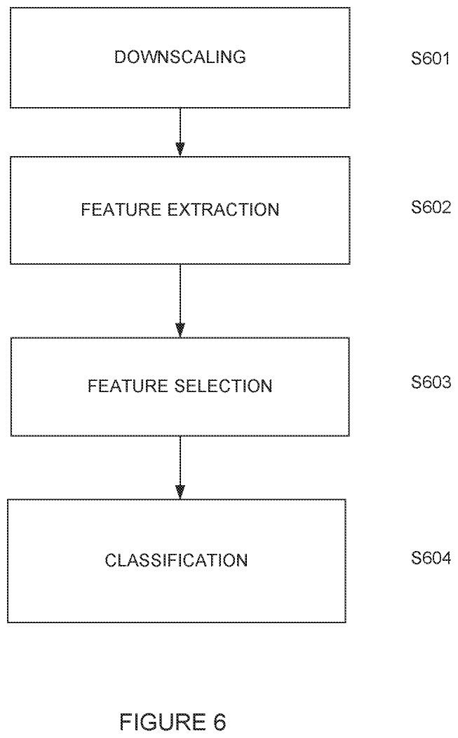

At step S404, the region of interest 104 is processed to generate data 105 indicative of a condition of the internal organ. In general, processing may include applying a machine learning technique to the extracted region of interest to generate the data 105 indicative of a condition of the internal organ. Further details are provided below with reference to FIG. 6.

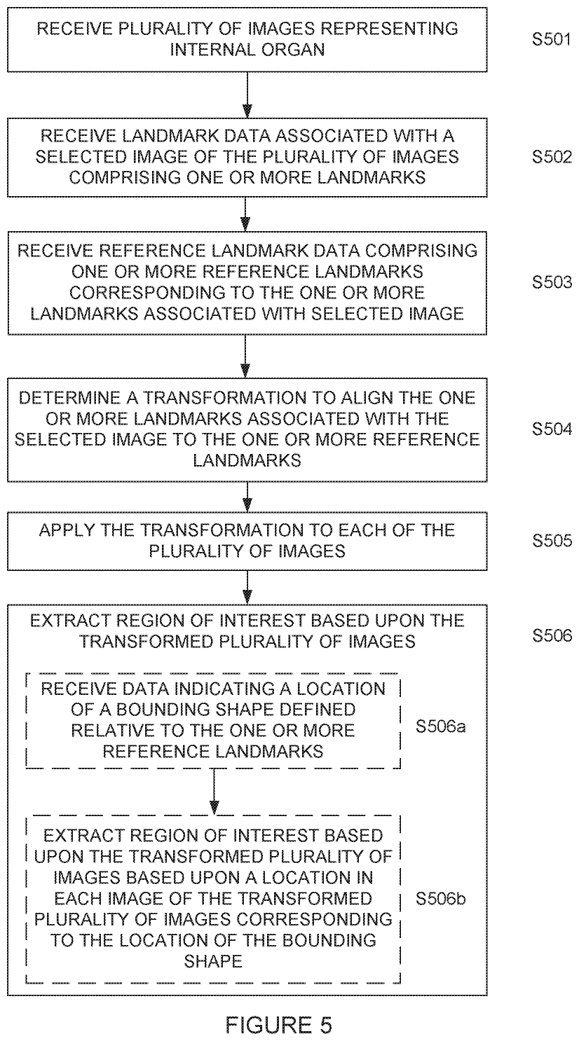

With reference to FIG. 5, alternative processing to that described above under step S403 is described. FIG. 5 begins with steps S501 and S502, which are identical to steps S401 and S402 in which a plurality of images 102 representing the internal organ and landmark data 103 associated with a selected image of the plurality of images are received. The landmark data 103 associated with the selected image comprises one or more landmarks.

At step S503, reference landmark data comprising one or more reference landmarks corresponding to the one or more landmarks associated with the selected image is received. As noted above, the one or more reference landmarks may be obtained based upon a reference image separate to the plurality of images 102.

Continuing at step S504, a transformation to align the one or more landmarks associated with the selected image to the one or more reference landmarks is determined. As described above, the transformation may include any combination of an image rotation, translation, scaling, flipping and any other suitable transformations in order to transform the selected image into the frame of reference defined by the one or more reference landmarks.

Optionally, as previously described, the computed transformation may be verified by computing a distance between the location of the transformed landmarks of the selected image and the reference landmarks. If the computed distance exceeds a threshold, this may be indicative of a poor quality alignment and a visual inspection may be required. The transformation may be re-computed to obtain an acceptable alignment or a manual alignment may be carried out instead.

At step S505, the determined transformation is applied to each of the plurality of images 102 and at step S506, the region of interest is extracted based upon the transformed plurality of images. Extracting the region of interest at step S506, may comprise the steps shown at S506a and S506b.

In more detail, at step S506a, data indicating a location of a bounding shape defined relative to the one or more reference landmarks is received. Alternatively, a reference image upon which the one or more reference landmarks are based may be received and the bounding shape defined relative to one or more reference landmarks may be determined.

At step S506b, a region of interest is extracted in each image of the transformed plurality of images based upon a location in each image of the transformed plurality images corresponding to the location of the bounding shape. As noted above, in this way, the bounding shape and its location need only be determined once based upon the one or more reference landmarks and can then be applied to any transformed image to extract the region of interest.

With reference to FIG. 6, exemplary processing for generating data indicative of a condition of the internal organ will now be described. Whilst the below is based upon processing of a plurality of masked images extracted by using the masking process as described above and as exemplified by FIG. 3B, it will be appreciated that the same processing can be applied to any image portion obtained by other methods of extraction than that described above.

At step S601, the plurality of masked images are downscaled in resolution. For example, a CINE cardiac MRI image may be of resolution 512×512 pixels and may be downscaled to 32×32, 64×64, 128×128 or other resolution as deemed appropriate. Downscaling may be performed in order to reduce the dimensionality of the data for later processing. This may be necessary for reasons of computational efficiency or if a size of a training dataset is much smaller than the dimensionality of the image data. FIG. 3C shows the result of a downscaling operation applied to the image of FIG. 3B.

At step S602, feature extraction is performed on the downscaled plurality of masked images. As discussed above, feature extraction may be performed based upon a tensor-based machine learning method such as MPCA. A training dataset may be used to learn appropriate features using MPCA which can then be extracted from the plurality of masked images currently undergoing processing. As discussed above, the learned features may have lower dimensionality than the input plurality of masked images and therefore the process of feature extraction may serve the dual purpose of feature extraction and dimensionality reduction.

At step S603, a subset of the extracted features from step S602 is selected. The subset of features that are to be selected may be pre-determined based upon applying a feature selection method on a training dataset. As discussed above, the feature selection method may be based upon a Fisher discriminant ratio to select the most discriminative features for differentiating between two classes such as internal organs having a particular condition indicative of disease and internal organs that appear to be healthy. Each feature may be ranked according to a computed Fisher discriminant ratio and the highest ranking features may be selected. Cross validation may be used to determine how many of the top ranking features are to be selected. Alternatively, other feature selection techniques may be used such as methods based upon mutual information.

At step S604, the selected set of features at step S603 are processed by a classifier to generate the data 105 indicative of a condition of the internal organ. For example, the data may indicate that the internal organ is diseased or that the internal organ is healthy. The classifier may be a linear classifier such as an SVM with linear kernel or logistic regression. The classifier may be trained based upon a training dataset using the selected set of features as input.

In an exemplary application of the above processing to cardiac MRI for diagnosis of pulmonary arterial hypertension, features including septal deviations, abnormal right ventricular blood pool flow patterns, and deformation of the left ventricular apex have been identified as particularly useful in the diagnosis or prognosis of the disease. It will be appreciated that application of the above processing will likely identify useful features for diagnosis of a variety of diseases associated with internal organs.

It will be appreciated that the above processing is exemplary and that it is possible to omit or substitute certain steps. For example, it is possible to omit the step of feature selection and process all extracted features using the classifier. In another example, it is possible to omit feature extraction and perform feature selection based upon the region of interest/plurality of images as a whole. In a further example, it is possible to omit both feature extraction and feature selection and process the region of interest/plurality of images directly using the classifier. The suitability of each processing step will be apparent to the person skilled in the art.

1. A method of generating data indicative of a condition of an internal organ, the method comprising:
receiving a plurality of images representing the internal organ;
receiving landmark data associated with a selected image of the plurality of images;
processing the landmark data and the selected image to extract a region of interest in the plurality of images; and
processing the region of interest in the plurality of images to generate data indicative of a condition of the internal organ.

2. The method of claim 1, wherein the plurality of images comprises a first image associated with a first time point and a second image associated with a second time point.

3. The method of claim 1, wherein the internal organ is associated with a physiological cycle and the plurality of images represents the physiological cycle.

4. The method of claim 3, wherein the physiological cycle is a cardiac cycle or a respiratory cycle.

5. The method of claim 1, wherein the plurality of images is obtained from an MRI scan, CT scan or ultrasound scan.

6. The method of claim 1, wherein the landmark data associated with the selected image comprises one or more landmarks and wherein processing the landmark data and the selected image to extract a region of interest in the plurality of images comprises:
receiving reference landmark data comprising one or more reference landmarks corresponding to the one or more landmarks associated with the selected image;
determining a transformation to align the one or more landmarks associated with the selected image to the one or more reference landmarks;
applying the transformation to each of the plurality of images;
extracting the region of interest based upon the transformed plurality of images.

7. The method of claim 6, further comprising:
receiving data indicating a location of a bounding shape defined relative to the one or more reference landmarks; and
extracting a region of interest in each image of the transformed plurality images based upon a location in each image of the transformed plurality images corresponding to the location of the bounding shape.

8. The method of claim 7, further comprising:
determining the bounding shape.

9. The method of claim 7, wherein the bounding shape encloses the one or more reference landmarks.

10. The method of claim 7, wherein the bounding shape is a circle or ellipse.

11. The method of claim 7, wherein extracting a region of interest in each image of the plurality of images comprises:
masking each image of the plurality of images outside of the bounding shape.

12. The method of claim 8, wherein determining the bounding shape comprises:
determining a minimum bounding shape that encloses the one or more reference landmarks.

13. The method of claim 1, further comprising:
downscaling a resolution of the plurality of images.

14. The method of claim 1, wherein processing the region of interest in the plurality of images to generate data indicative of a condition of the internal organ is based upon a machine learning technique.

15. The method of claim 14, wherein processing the region of interest further comprises:
applying a classifier to generate data indicative of a condition of the internal organ.

16. The method of claim 14, wherein processing the region of interest further comprises:
generating image features based upon a tensor-based machine learning technique applied to the region of interest in the plurality of images; and
applying a classifier to the image features to generate data indicative of a condition of the internal organ.

17. The method of claim 14, further comprising:
applying a feature selection technique to select image features; and
applying the classifier to the selected image features to generate data indicative of a condition of the internal organ.

18. The method of claim 17, wherein the feature selection technique is based upon a Fisher discriminant ratio.

19. The method of claim 15, wherein the classifier is a linear classifier.

20. The method of claim 1, further comprising:
monitoring the condition of the internal organ by comparing the data indicative of a condition of the internal organ to previously generated data indicative of a condition of the internal organ.

21. A computer apparatus for generating data indicative of a condition of an internal organ comprising:
a memory storing processor readable instructions;
a processor arranged to read and execute instructions in said memory; wherein said processor readable instructions comprise instructions arranged to control the computer to carry out a method according to claim 1.

22. A non-transitory computer readable medium carrying computer readable instructions configured to cause a computer to carry out a method according to claim 1.
